(19) United States
(12) Patent Application Publication
(10) Pub. No.: US 2006/0111841 A1
(43) Pub. Date: May 25, 2006

(54) Method and apparatus for obstacle avoidance with camera vision

(76) Inventor: Jiun-Yuan Tseng, Chenggong Township (TW)

Correspondence Address: John S. Egbert;Egbert Law Offices, 7th Floor, 412 Main Street, Houston, TX, 77002, US

(21) Appl. No.: 11/260,723

(22) Filed: Oct. 27, 2005

(30) Foreign Application Priority Data
Nov. 19, 2004 (TW) 093135791
May 27, 2005 (CN) 2005100730594

(51) Int. Cl. G08G 1/16

(52) U.S. Cl. 701/301; 340/903; 340/436

(57) ABSTRACT

The present invention relates to a method and an apparatus of operating an obstacle avoidance system with camera vision. The invention is used during both day and night, and provides a strategy of obstacle avoidance without complicated fuzzy inference for safe driving. The method includes the following steps: analyzing plural images of an obstacle, positioning an image sensor, providing an obstacle recognizing flow, obtaining an absolute velocity of a system carrier, obtaining a relative velocity and a relative distance of the system carrier with respect to the obstacle, and providing a strategy of obstacle avoidance.

### BACKGROUND OF THE INVENTION 1. Field of the Invention

The present invention relates to an apparatus of obstacle avoidance and a method thereof, and more particularly to an apparatus of obstacle avoidance and a method thereof based on image sensing, which is especially suitable for obstacle avoidance in transportation settings.

2. Description of the Related Art

In Taiwan, many academic institutes have focused on research of collision avoidance. For example, in the integrated project, Intelligent Transportation System (ITS), conducted by National Chiao Tung University, the supersonic sensors are used to measure the distance between vehicles. In other countries, researches regarding the security system of vehicles have been conducted for years, and the related information systems have been combined with security systems to form an ITS. Currently, an Automotive Collision Avoidance System (ACAS) has been developed, in which an infrared ray is used to measure the distance between the driver's vehicle and the vehicle in front to calculate the relative velocity between them. Then, the driver is advised to take action via a man-machine interface. The structure of ACAS is explained with three flows: receiving the environmental information, recognizing vehicles by captured images, and developing a strategy of vehicle avoidance.

The function of sensors is to obtain information regarding the external environment. Up to now, the types of sensors used in related experiments include supersonic sensors, radio wave sensors, infra ray sensors, satellite positioning, and CCD cameras. A comparison table of sensing techniques is shown in Table 1 below.

TABLE 1

| Sensing | | | Laser | Satellite | |
|---|---|---|---|---|---|
| technique | Super sonic | Radio wave | (infrared) | positioning | CCD camera |
| Operation | Doppler effect | Doppler effect | Infrared effect | Global | Transformation |
| Theory | | | | Positioning | from image |
| | | | | System | plane to real |
| | | | | | space, |
| | | | | | intelligent |
| | | | | | image |
| | | | | | identification |
| Advantage | No harm to | Medium to | Longer | Guidance | Sensing |
| | humans, | long sensing | sensing | capability | distance up to |
| | cheap, easy | distance | distance | | 100 m, |
| | implementation. | (100˜200 m) | (500˜600 m), | | providing |
| | | | accurate. | | whole road |
| | | | | | information |
| | | | | | including |
| | | | | | sideline |
| | | | | | detection, |
| | | | | | distance from |
| | | | | | car in front, |
| | | | | | velocity, and so |
| | | | | | on. |
| Disadvantage | Short sensing | Harmful to | Harmful to | Expensive, | Affected by |
| | distance | human and | human eyes | about 10 m | brightness of |
| | (0˜10 m) and | poor road | and poor road | positioning | the sky, but |
| | poor road | information. | information. | error, and | remediable by |
| | information. | | | more than one | intelligent |
| | | | | GPS required. | signal |
| | | | | | processing. |
| Application | Vehicle | Police speed | Police speed | Satellite | Industrial image |
| | backing | detector and | detector and | guidance | detection, setup |
| | monitoring and | vehicle | vehicle | | of robot vision |
| | vehicle | avoidance | avoidance | | and vehicle |
| | avoidance | | | | avoidance |

From Table 1, CCD camera technology can provide much more road information, but is sensitive to available light and cannot be applied in obstacle identification at night.

So far, many vehicle identification methods have been proposed, including “A method for identifying specific vehicles using template matching” proposed by Yamaguchi, “Location and relative speed estimation of vehicles by monocular vision” by Marmoiton, “Preceding vehicle recognition based on learning from sample images” by Kato, “Real-time estimation and tracking of optical flow vectors for obstacle detection” by Kruger, and “EMS-vision: recognition of intersections on unmarked road networks” by Lutzeler. Table 2 shows the comparison between the methods mentioned above.

TABLE 2

| | | | | Boundary |
|---|---|---|---|---|
| | Template | Monocular | Pattern | combination of |
| | matching | vision | recognition | vehicle images |
| Operation | Determine the | Recognizing a | Finding the | Using the |
| theory | distance by the | front vehicle | eigenvectors of | boundary |
| | amount of | by three easily | vehicle by | distribution of |
| | pixels of the | recognizable | neural network | images of a |
| | template | marks with | training. | vehicle |
| | | known relative | | |
| | | positions. | | |
| Application | Parking | Active safe | Defect | Active safe |
| | management | driving | detection of | driving assistant |
| | system | assistant | steel plate and | system |
| | | system | face | |
| | | | recognition | |
| Algorithm | High-pass | Exact | Neural network | Performing |
| | filter | perspective for | training | robust boundary |
| | | a triplet of | | search by |
| | | points | | HCDFCM |
| Utilization of | Medium; | Medium; | High; | Low; |
| CPU resource | CCD camera | CCD camera | Required neural | Only the pixel |
| | as input for | as input for | network | values on a line |
| | capturing | capturing | training that | segment in an |
| | images; one | images; one | determines the | image (up to |
| | input, one | input, one | quality of | 720 pixels) |
| | image; but | image; but | recognition. | |
| | more | more | | |
| | utilization | utilization | | |
| | when | when | | |
| | performing | performing | | |
| | image | image | | |
| | processing | processing | | |
| Pre-determined | Parameters of | Coordinates of | Build-up of | Boundary |
| parameters or | high-pass | the front three | template | distribution of |
| information | Filter | points | database and | images of a |
| | | | neural network | vehicle |
| Implementation | Difficult; | Medium | Difficult; | Easy |
| | Simple | | Representative | |
| | background is | | totems of | |
| | required; | | vehicles and | |
| | applicable | | roads are | |
| | within 10 m. | | required for | |
| | | | training | |
| Sensing range | Short; | Medium; | Medium; | Medium; |
| | Within 10 m | Around 100 m | Around 100 m | Around 100 m |
| Accuracy | Not high | High | Not high | High |
| Computation | Medium | Medium | Medium | High |
| efficiency | | | | |
| Cost | Low | Medium | High | Low |

Developing a strategy of vehicle avoidance is mainly to simulate a driver's reactions before colliding with the front vehicle. In general, the driver takes proper actions to avoid an accident by observing the distance and the relative velocity with respect to the front vehicle. Regarding the active driving security system, there have been many strategies of vehicle avoidance proposed. Among these, the car-following collision prevention system (CFCPS) proposed by Mar J. has achieved an excellent performance. In the CFCPS, both the relative velocity and the result of subtracting the safe distance from the relative distance as inputs, a fuzzy inference engine based on 25 fuzzy rules as a computation core, a basis for accelerating or decelerating the vehicle is obtained. In addition, regarding the time required when the vehicle becomes safe and stable, that is, the relative distance equals the safe distance and the relative velocity is zero, the CFCPS takes from seven to eight seconds. From experiments similar to that of the CFCPS, the General Motors model takes ten seconds and the Kikuchi and Chakroborty model takes from 12 to 14 seconds.

### SUMMARY OF THE INVENTION

The primary objective of the present invention is to disclose a method and an apparatus for all-weather obstacle avoidance to perform obstacle recognition during the day and at night, in which the complex inference of fuzzy rules is not required to provide a strategy of obstacle avoidance as a reference for the driver of a system carrier.

The secondary objective of the present invention is to disclose a method and an apparatus for all-weather obstacle avoidance to recover the position of an image sensor on the system carrier without measurement on the spot after the system carrier is bumped.

In order to achieve the objectives, the present invention discloses a method and an apparatus for obstacle avoidance with camera vision, which is applied in the system carrier carrying the image sensor. The method for obstacle avoidance comprises the following steps (a)˜(f): (a) capturing and analyzing plural images of an obstacle; (b) positioning the image sensor; (c) performing an obstacle recognition flow; (d) obtaining an absolute velocity of the system carrier; (e) obtaining a relative velocity and a relative distance of the system carrier with respect to the obstacle; and (f) performing a strategy of obstacle avoidance. In some embodiments, the captured images in the step (a) could be obtained from the front, the rear, the left side or the right side to the system carrier or could be obtained at a second instant.

The aforementioned method for obstacle avoidance is performed in an apparatus for obstacle avoidance, which is set up on the system carrier. The apparatus for obstacle avoidance comprises an image sensor, an operation unit and an alarm. The image sensor captures plural images of the obstacle and is used to recognize the obstacle. The operation unit analyzes the plural images. If the obstacle exists, the alarm emits light and sound or generates vibration.

### BRIEF DESCRIPTION OF THE DRAWINGS

The invention will be described according to the appended drawings.

FIG. 1 illustrates the present invention of an apparatus for obstacle avoidance.

FIG. 2 is a flow chart of the present invention of a method for obstacle avoidance.

FIG. 3 is a flow chart of analyzing plural images of an obstacle in FIG. 2.

FIG. 4 illustrates an imaging geometry regarding the relative distance measurement.

FIG. 5 illustrates a photosensitive panel of a CCD camera.

FIG. 6 illustrates an imaging geometry regarding the transverse distance measurement.

FIG. 7 illustrates the height measurement of an obstacle (a car) in the image.

FIG. 8(a)˜(d) illustrate different l_{dw}, with different relative distances of the car in the image.

FIG. 9 illustrates an image geometry regarding positioning of the image sensor.

FIG. 10 is a flow chart of performing an obstacle recognition in FIG. 2.

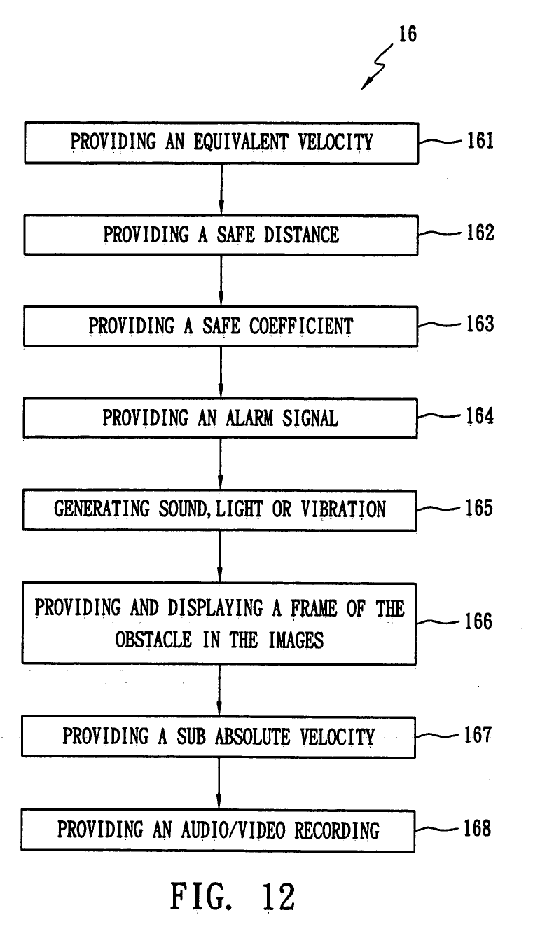

FIG. 11(a)˜(f) illustrate six scan modes.

FIG. 12 is a flow chart of performing a strategy of obstacle avoidance in FIG. 2.

FIG. 13(a), 13(b) and 13(c) illustrate the obstacle recognition by Boolean variables.

FIG. 14 illustrates the effect of the reflected light from the road under rainy night conditions.

FIG. 15 illustrates a frame of an obstacle in a captured image.

### PREFERRED EMBODIMENT OF THE PRESENT INVENTION

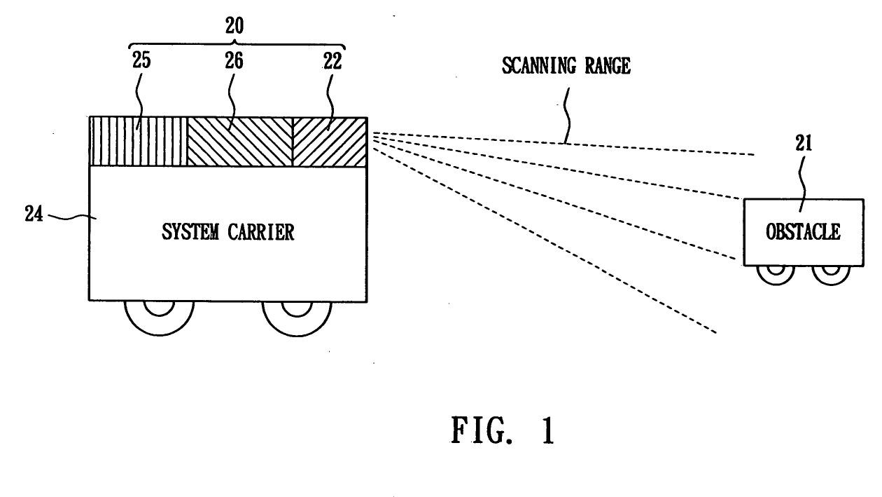

FIG. 1 illustrates the present invention of an apparatus for obstacle avoidance 20, which is set up on a system carrier 24. The apparatus for obstacle avoidance 20 comprises as image sensor 22, an operation unit 26 and an alarm 25. The image sensor 22 scans an obstacle 21 and captures plural images of the obstacle 21. The operation unit 26 analyzes the plural images of the obstacles 21. If the obstacle 21 exists, the alarm 25 will emit light and sound or generate vibration. In other embodiments, the image sensor 22 could be set up in the front, the rear, the left side or the right side to the system carrier 24 to capture the images, or the image sensor 22 could capture the images at a first instant and a second instant.

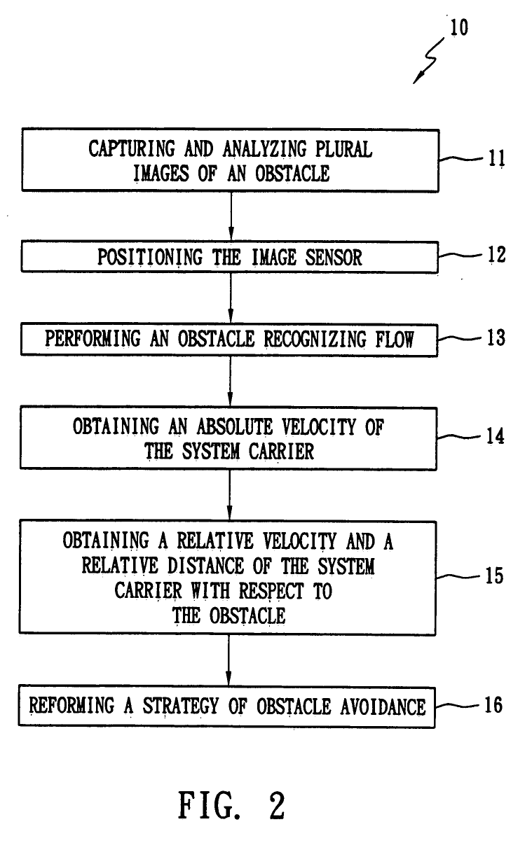

FIG. 2 is a flow chart of the present invention of a method for obstacle avoidance 10, which comprises the steps 11 to 16. Step 11 captures and analyzes plural images of the obstacle 21. Step 12 positions the image sensor 22. Step 13 performs an obstacle recognition flow. Step 14 obtains an absolute velocity of the system carrier 24. Step 15 obtains a relative velocity and a relative distance of the system carrier with respect to the obstacle. Step 16 performs a strategy of obstacle avoidance. Each of the steps 11 to 16 is described in detail as follows.

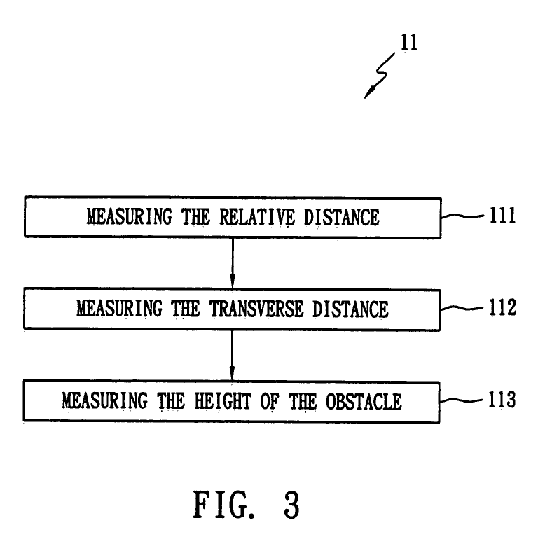

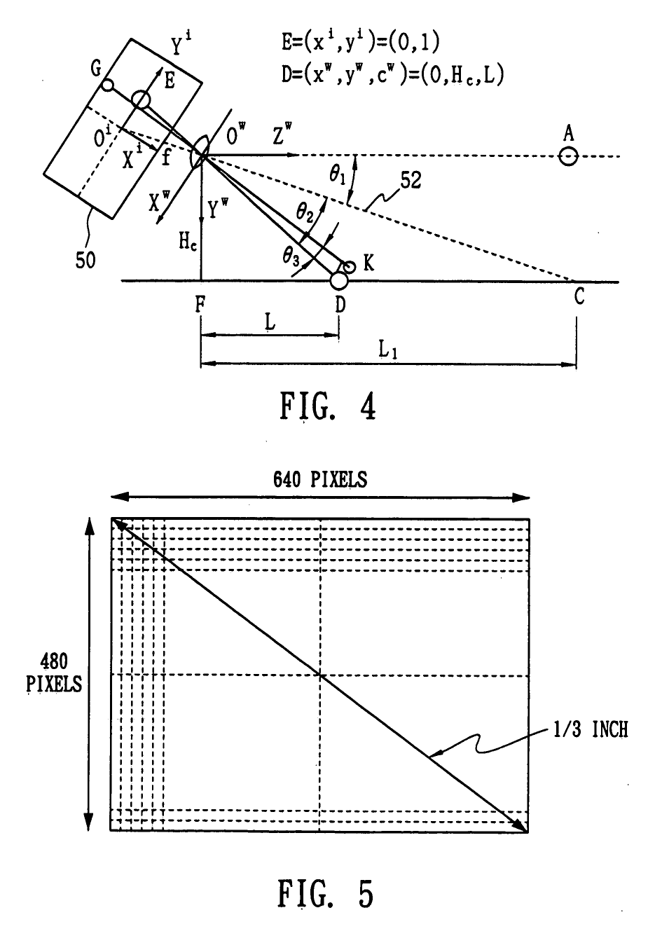

Step 11 is to capture and analyze plural images of the obstacle 21, which comprises the steps of (refer to FIG. 3):
(a) Measuring the relative distance 111 (i.e., the relative distance of the system carrier 24 with respect to the obstacle 21): FIG. 4 illustrates an imaging geometry regarding the relative distance measurement, which contains two coordinate systems. One is the two-dimensional image plane (Xⁱ,Yⁱ), and the other is the three-dimensional real space (X^{w}, Y^{w},Z^{w}). The origin of the former is the central point Oⁱ on the image plane 50 and the origin of the latter, O^{w}, is the physically geometric center of the image sensor 22. H_{c} (Height of the image sensor 22) is representative of the vertical distance from the point O^{w} to the ground (i.e., \overline{O^{w}F}). f is the focal length of the image sensor 22. The optical axis of the image sensor 22 is indicated by an arrowhead line, \vec{OⁱO^{w}}, which intersects the Horizon (i.e., the line passing the points C and D) at point C. The point A is on an arrowhead line, \vec{O^{w}Z^{w}}, which is parallel with the Horizon. The target point D is located in the front of the point F with a distance L and the target point D corresponds to the point E in the image plane 50.

Let l =\overline{OⁱE}, L₁=\overline{FC}, θ₁=∠AO^{w}C, θ₂=∠CO^{w}D=∠EO^{w}Oⁱ and θ₃=∠KO^{w}D=∠GO^{w}E. We can obtain the following relationships (1) to (6):

$$\begin{matrix}{θ}_{1} = {tan}^{- 1} ( \frac{{H}_{C}}{{L}_{1}} ) & ( 1 ) \\ = {tan}^{- 1} ( \frac{Δ {p}_{l}^{*} ( c - {y}_{1} )}{f} ) & ( 2 ) \\ {θ}_{2} = {tan}^{- 1} ( \frac{l}{f} ) & ( 3 ) \\ L = \frac{{H}_{C}}{tan ( {θ}_{1} + {θ}_{2} )} & ( 4 ) \\ l = {p}_{l} \times Δ {p}_{l} & ( 5 ) \\ {p}_{l} = \frac{f}{Δ {p}_{l}} \times tan ( ( {tan}^{- 1} \frac{{H}_{C}}{L} - {θ}_{1} ) ) & ( 6 )\end{matrix}$$

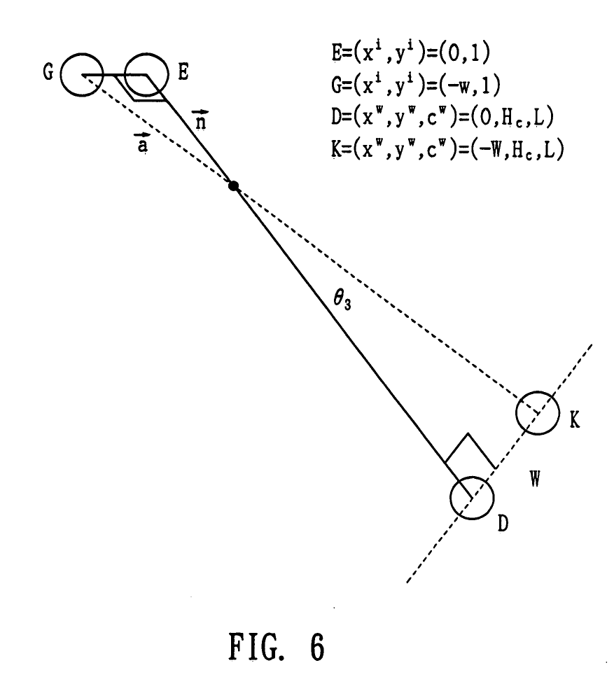

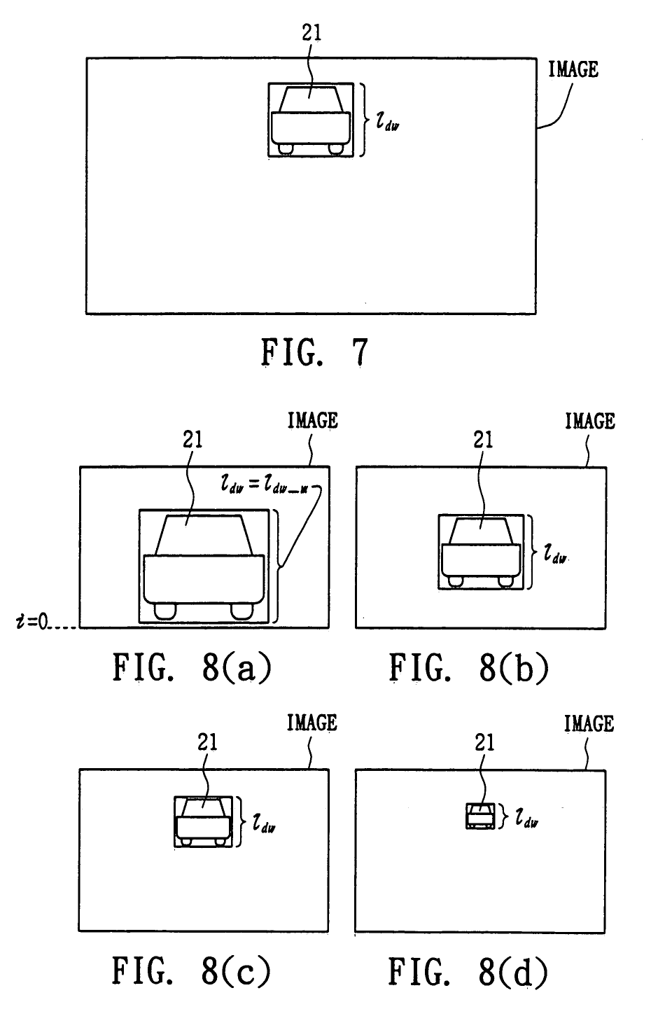

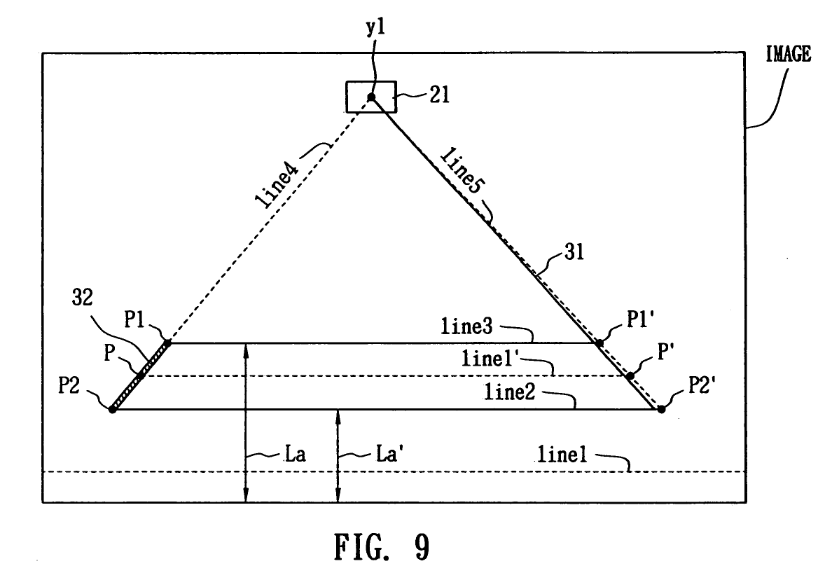

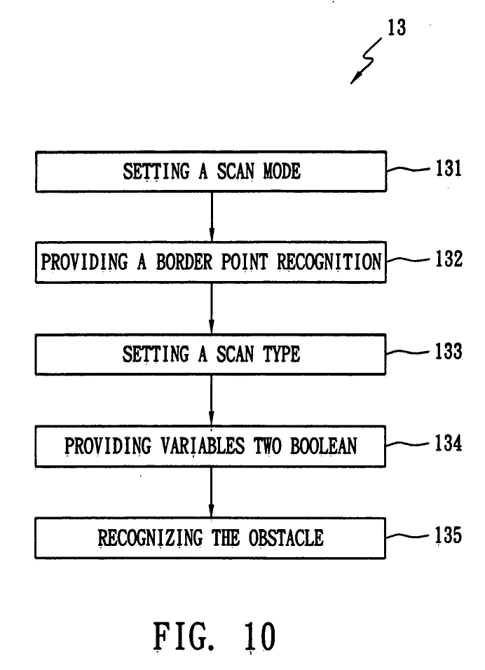

Here f is known and c is chosen as a half of the vertical length of the images (for example, c is 120 for the images of 240×320), H_{c} and L₁ are obtained by measurement. y₁ indicates the position of the far end of a straight road in the image, which is determined rapidly by the driver through the image. θ₁ is the depression angle of the image sensor 22, which affects the mapping between the two-dimensional image plane and the three-dimensional real space. Relationships (1) and (2) are two simple methods of image calibration, which result in the depression angle θ₁ without instruments of angle measurement. l in relationship (3) is determined by relationships (5) and (6) and through an image processing, where pₗ is the pixel length indicating the pixel amount of the line segment \overline{OⁱE}, Δpₗ is the interval of pixels on the image plane. L obtained in relationship (4) is the real distance from the image sensor 22 to the obstacle 21.
The measurement of Δpₗ depends on the hardware architecture of the image sensor 22; for example, a photosensitive panel of a CCD camera, is shown in FIG. 5. In the example of FIG. 5, the pixel resolution of the photosensitive panel is 640×480 (pₓ*p_{y}) , which receives the light signals and the length of the diagonal S is one-third inch. Therefore, Δpₗ (in mm), the interval of pixels on the image plane, can be determined by relationship (7) as follows.

$$\begin{matrix}Δ {p}_{l} = S \times \frac{{p}_{y}}{\sqrt{{p}_{x}^{2} + {p}_{y}^{2}}} \times \frac{1}{{p}_{y}} \\ = \frac{1}{3} \times \frac{2}{\sqrt{13}} \times \frac{1}{480} = 9.77 \times {10}^{- 3}\end{matrix} \qquad ( 7 )$$
In addition, L can be determined from relationship (8) below, which is based on relationships (1) to (4) and the images.

$$L = \frac{{H}_{C}}{tan ( {θ}_{1} + {θ}_{2} )} = \frac{{H}_{c}}{tan ( {tan}^{- 1} ( \frac{{H}_{C}}{{L}_{1}} ) + {tan}^{- 1} ( \frac{{p}_{l} \times Δ {p}_{l}}{f} ) )} \qquad ( 8 )$$
When f (the focal length of the image sensor 22) is known, pₗ (pixel length) can be known by observing FIG. 4 and H_{c}, L₁ and L can be obtained by measurement. Then, Δpₗ is determined. To obtain a representative Δpₗ, we can get an average of plural Δpₗ's as the representative Δpₗ because each different Pₗ corresponds to one different Δpₗ or we can solve multiple equations regarding Δpₗ and f. An experimental result shows Δpₗ is 8.31×10⁻³ (mm) with accuracy of 85%.
(b) Measuring the transverse distance 112: FIG. 6 illustrates an imaging geometry regarding the transverse distance measurement, which is a magnification of the segment lines \overline{KG} and \overline{DE} in FIG. 4. In FIG. 6, the point D moves a distance W in the negative direction of X^{w} to arrive at the point K with a real space coordinate (−W, H_{c}, L). The point G in the image plane is the imaging point of the point K in the real space. The image plane coordinate of the point G is (−w, l). Let \vec{n} denote the vector \vec{O^{w}E} and \vec{a} denote the vector \vec{O^{w}G} and we can obtain relationships (9) and (10) as follows.

$$\begin{matrix}{θ}_{3} = {cos}^{- 1} \frac{{n}^{->} \cdot {a}^{->}}{\vert {n}^{->} \vert \vert {a}^{->} \vert} & ( 9 ) \\ \begin{matrix}W = {H}_{C} csc ( {θ}_{1} + {θ}_{2} ) tan {θ}_{3} \\ = w \times \frac{\sqrt{{H}_{C}^{2} + {L}^{2}}}{\sqrt{{f}^{2} + {l}^{2}}}\end{matrix} & ( 10 )\end{matrix}$$
(c) Measuring the height of the obstacle 113: FIG. 7 illustrates the height measurement of an obstacle in the image in the embodiment of a car as the obstacle 21. In the image of FIG. 7, the imaging range of the car 21 is surrounded by a rectangular frame with the length of detection window l_{dw} that can be determined from relationship (11) below.
l_{dw}=c+pₗ′−i (11)
where c is one half of the vertical length of the images (c is selected to 240/2=120 for 240×320 images), i is the vertical coordinate of the rear of the car 21 in the image plane. pₗ′ can be obtained from the following relationship (12).

$${p}_{l}^{′} = \frac{f}{Δ {p}_{l}} \times tan ( {θ}_{1} + {tan}^{- 1} ( \frac{{H}_{V} - {H}_{C}}{L\_p} ) ) \qquad ( 12 )$$

where Hᵥ is the height of the car 21, H_{c} is the width of the car 21 and L_p is the relative distance from the system carrier 24 to the car 21 in the real space, which corresponds to the position of the value of i. FIGS. 8(a)˜(d) illustrate different l_{dw} with different relative distances for the same car 21 in the image, and in the meanwhile, the image sensor 22 is still. L_p can be obtained by relationship (13) below.

$$L\_p = \frac{{H}_{C}}{tan ( {θ}_{1} + {θ}_{2} )} \qquad ( 13 )$$

where θ₂=∠CO^{w}D=∠EO^{w}Oⁱ (refer to FIG. 4).

Table 3 is the experimental results according to FIG. 8(a) to 8(d) to verify if relationships (11) to (13) are feasible. The experimental parameters used are Hᵥ=134 cm, L₁=1836 cm and H_{c}=129 cm. From the last column of Table 3, the average of error is about 7.21%, i.e., the accuracy is above 90%. Therefore, relationships (11) to (13) are practical.

TABLE 3

| | i | L_p (m) | l_{dw} | l_{dw}^{′} | $Error ( \% ) , \vert \frac{{l}_{dw}^{′} - {l}_{dw}}{{l}_{dw}^{′}} \vert$ |
|---|---|---|---|---|---|
| FIG. 8 (a) | 38 | 6.8 | 135 | 140 | 3.57 |
| FIG. 8 (b) | 96 | 12.4 | 75 | 79 | 5.06 |
| FIG. 8 (c) | 130 | 23.4 | 40 | 44 | 9.09 |
| FIG. 8 (d) | 157 | 78.5 | 12 | 13.5 | 11.11 |

Note:
l_{dw} denotes the length of detection window obtained from relationships (11) to (13), and l_{dw}^{′} denotes the length of detection window obtained by measurement.

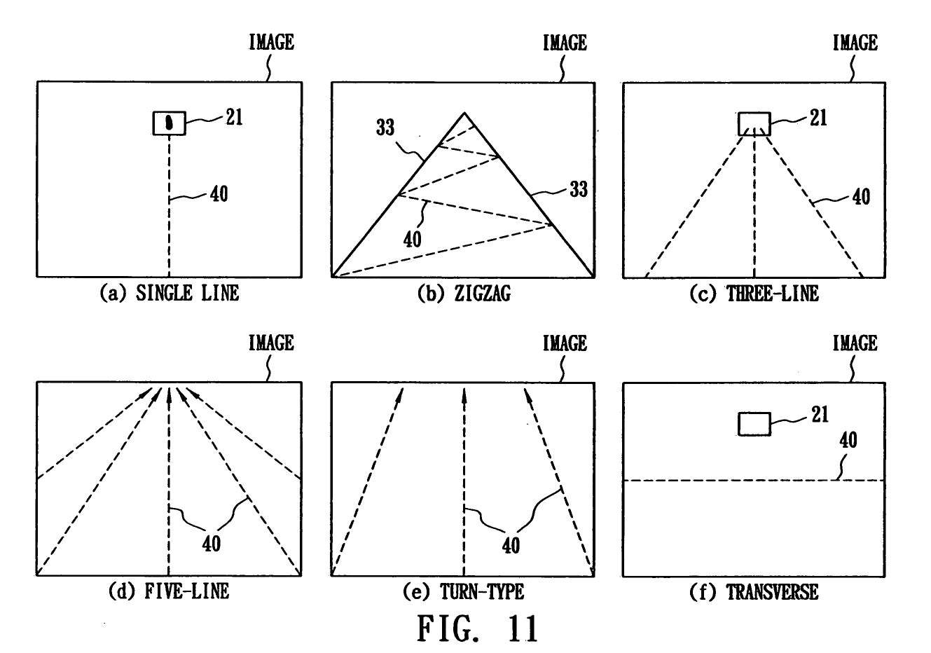

Step 12 is to position the image sensor 22 and comprises the steps of (refer to FIG. 9):
(a) Scanning horizontally the images with line1 from the bottom to the top with an interval of three to five meters. When scanning at the position of line1′, the character points P and P′, which both have the character of sidelines of the road and are located on a first character line segment 32 and a second character line segment 31, respectively, are found.
(b) Beginning at the character point P along the first character line segment 32, finding two first points P1 and P2 located at both ends of the first character line segment 32. Forming two horizontal lines line2 and line3 through the first points P2 and P1, respectively. Two second points P2′ and P1′ are intersection points of line2 and the second character line segment 31, line3 and the second character line segment 31, respectively.
(c) Determining the intersection point y1 of line4 and line5, where line4 and line5 are arrowhead lines of \vec{P1P2} (line4) and \vec{P1′P2′} (line5), respectively.
(d) Determining the depression angle θ₁ of the image sensor 22 by relationship (2) and the intersection point y1 obtained above.
(e) From FIG. 9 and relationship (4), we can obtain relationship (14) below.

$$\{ \begin{matrix}La = \frac{{H}_{c}}{tan ( {θ}_{1} + {θ}_{2} )} \\ {La}^{′} = \frac{{H}_{c}}{tan ( {θ}_{1} + {θ}_{2}^{′} )}\end{matrix} \qquad ( 14 )$$

where La and La′ are the relative distances from the image sensor 22 to line3 and to line2, respectively. Also referring to FIG. 4, θ₂ and θ₂′ denote different angles of ∠CO^{w}D defined according to La and La′, respectively. From relationship (14), we can get relationship (15) below.

$${H}_{c} = \frac{{C}_{1}}{( \frac{1}{tan ( {θ}_{1} + {θ}_{2} )} - \frac{1}{tan ( {θ}_{1} + {θ}_{2}^{′} )} )} \qquad ( 15 )$$

where C₁ is the length of a line segment on the road. After the depression angle θ₁ and the distance from the image sensor to the ground H_{c} are known, the position of the image sensor 22 is determined.

By the technique of image analysis disclosed above, the depression angle θ₁ and the height of the image sensor 22 can be obtained without measurement, so the position of the image sensor 22 can be recovered automatically if it is shifted.

The determination of θ₁ and H_{c} described above is based on the two known parameters of f (the focal length of the image sensor 22) and Δp₁ (the interval of pixels on the image plane). The two parameters of f and Δp₁ can be determined directly from analyzing the captured images as follows. From relationship (15), we can induce relationship (16) below. Similarly, we can get relationship (17) below from relationship (16).

$$\begin{matrix}{H}_{c} \times ( \frac{tan ( {θ}_{1} + {θ}_{2}^{′} ) - tan ( {θ}_{1} + {θ}_{2} )}{tan ( {θ}_{1} + {θ}_{2} ) \times tan ( {θ}_{1} + {θ}_{2}^{′} )} ) = {C}_{1} & ( 16 ) \\ {H}_{c} \times ( \frac{tan ( {θ}_{1} + {θ}_{2}^{′′} ) - tan ( {θ}_{1} + {θ}_{2} )}{tan ( {θ}_{1} + {θ}_{2} ) \times tan ( {θ}_{1} + {θ}_{2}^{′′} )} ) = {C}_{10} & ( 17 )\end{matrix}$$

where C₁ is the length of a line segment on the road, C₁₀ is an interval of line segments on the road, and both C₁ and C₁₀ are known. H_{c} is the distance from the image sensor to the ground, θ₁ is the depression angle of the image sensor. H_{c}, θ₁, θ₂, θ₂′ and θ₂″ are functions of f and Δpₗ, f is the focus of the image sensor Δpₗ is the interval of pixels on the image plane. Now we have two unknowns (f and Δpₗ) and two equations (i.e., relationships (16) and (17)), so f and Δpₗ can be determined.

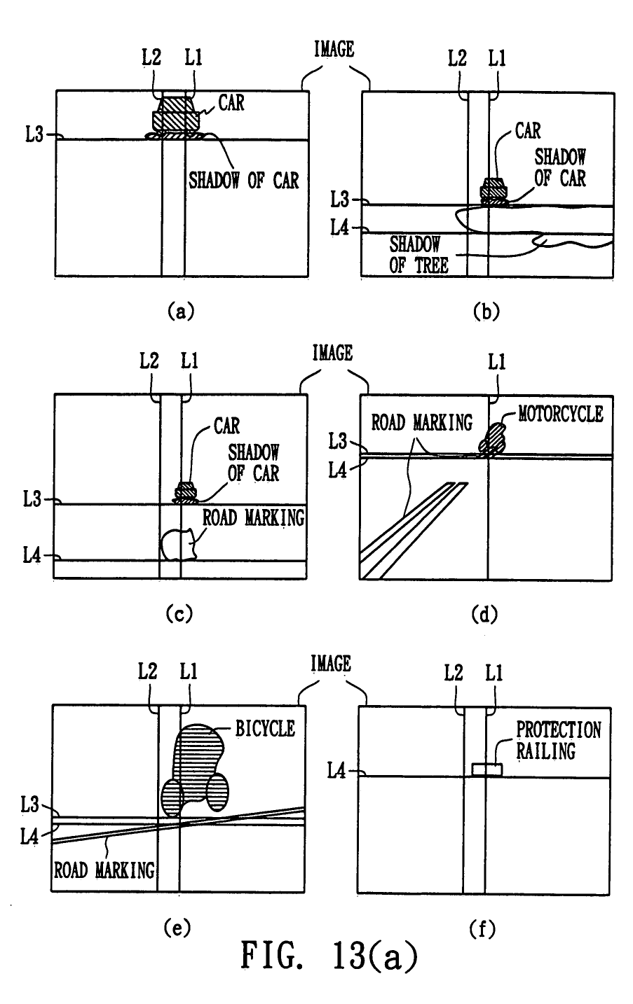

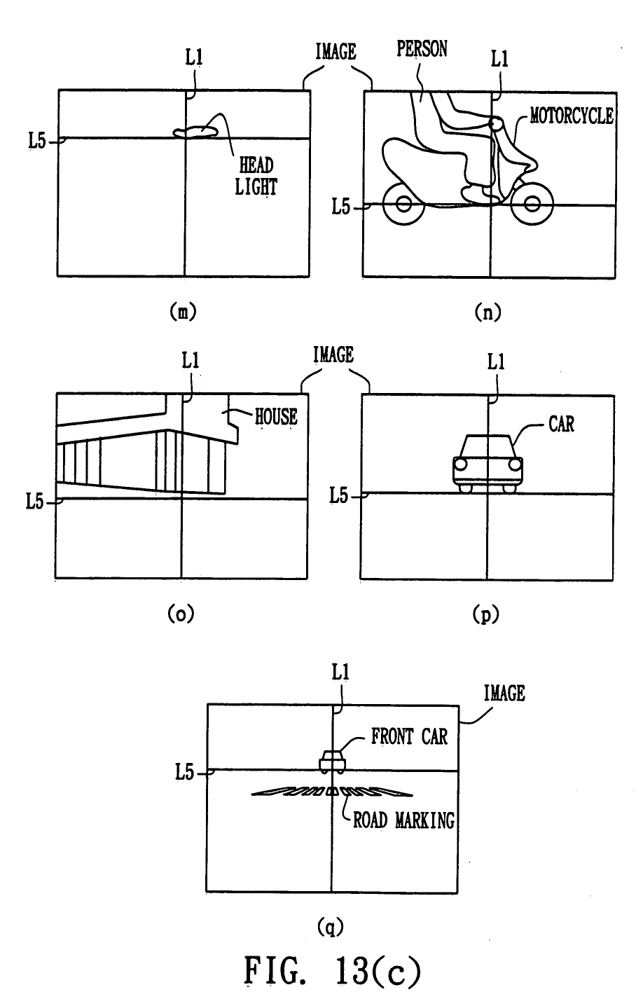

Step 13 is to perform an obstacle recognition flow, which comprises the steps of:
(a) Setting a scan mode 131: referring to FIG. 11(a) to 11(f), the scan mode is selected from the group consisting of a single line scan mode, a zigzag scan mode, a three-line scan mode, a five-line scan mode, a turn-type scan mode and a transverse scan mode. Each of the scan modes is described as follow. The width and the depth (i.e., the relative distance from the image sensor 22) of the scanning range are both adjustable.
Mode 1: The single line scan mode, illustrated in FIG. 11(a). A scanning line 40 advances vertically upward from the bottom and approaches to the obstacle 21.
Mode 2: The zigzag scan mode, illustrated in FIG. 11(b). The triangular area defined by two boundaries 33 and the bottom of the image is the scanning range reached by the image sensor 22 set up in the front of the system carrier 24. The scanning line 40 moves from the bottom of the image following a zigzag path, and changes direction after reaching the boundary 33. In a preferred embodiment, the width of the scanning range is in the range of meters.
Mode 3: The three-line scan mode, illustrated in FIG. 11 (c). The width of the scanning range of the image senor 22 is about one and a half times the width of the system carrier 24. The scanning range is covered by three scanning lines 40.
Mode 4: The five-line scan mode, illustrated in FIG. 11(d). The scanning range is covered by five scanning lines 40, which uses two more scanning lines 40 than Mode 3.
Mode 5: The turn-type scan mode, illustrated in FIG. 11(e). Compared to FIG. 11(c), the right- and left-sides of the scanning range are widened. Mode 5 is especially suitable for turning vehicles.
   Mode 6: The transverse scan mode, illustrated in FIG. 11(f). The scanning line 40 scans horizontally and approaches the obstacle 21.
Mode 4 can be used to detect cars which are oncoming, which at crossings do not have the right-of-way and stop suddenly in the path of traffic, or which overtake from behind and suddenly swerve directly in front. Being able to detect oncoming cars, Mode 4 can be used to perform automatic switching between the high beam and the low beam of the car and adjust the speed of the car when passing another oncoming car. The mechanism of automatic switching operates when the relative distance of system carrier 24 with respect to the obstacle 21 in the oncoming way is below a specific distance.
(b) Providing a border point recognition 132: First, the Euclidean distance of pixel values between a pixel and its following pixel is calculated. For color images, E (k) denotes the Euclidean distance between the k^{th} and the (k+1)^{th} pixels, and is defined as

$$\frac{\sqrt{{( {R}_{k + 1} - {R}_{k} )}^{2} + {( {G}_{k + 1} - {G}_{k} )}^{2} + {( {B}_{k + 1} - {B}_{k} )}^{2}}}{3} ,$$

where Rₖ, Gₖ and Bₖ denote the red, green and blue pixel values of the k^{th} pixel, respectively. If E (k) is larger than C₂, the k^{th} pixel is treated as a border point, where C₂ is a critical constant given by experience. For gray-scale images, E(k) is defined as Grayₖ₊₁, −Grayₖ, where Grayₖ denotes the gray pixel value of the k^{th} pixel. If E (k) is larger than C₃, the k^{th} pixel is treated as a border point, where C₃ is a critical constant given by experience.
(c) Setting a scan type 133: The scan type is one of a detective type or a gradual type, which is explained in detail as follows.
   (c.1) The detective type: When a border point is found during scanning, it is considered as the position of the rear of the obstacle 21, and a detection window based on the border point will be established. Referring to FIG. 7, the detection window is a rectangular frame with the length of the detection window l_{dw}, which encloses the car 21. Then, the pixel information inside the detection window is analyzed. The length of the detection window l_{dw} depends on the relative distance from the image sensor 22 to the obstacle 21. FIGS. 8(a)˜(d) illustrate different l_{dw} with different relative distances for the same car 21 in the image. Scanning stops at the position with an ordinate of l_{dw}_{_{—}}ₘ, illustrated in FIG. 8(a).
   (c.2) The gradual type: There is no detection window built in this scan type when scanning. Scanning stops, in general, at the position of the end of a road in the image.
(d) Providing two Boolean variables. One is regarding the shadow character of the obstacle. The other is regarding the brightness decay character of the projected light or the reflected light from the obstacle 134:
(d.1) The character of the dark-color under the obstacle 21: the dark-color includes the color of shadow and the color of the tire of the system carrier 24. Under light, three-dimensional objects will cause shadows under them, but non-three-dimensional objects, such as road markings, will not cause shadows. Therefore, the shadow character can be used to recognize the obstacle 21. We provide a Boolean variable BA regarding the shadow character of the obstacle 21, and the true value of BA can be determined by relationships (18) and (19) below.

$$\begin{matrix}If \frac{{N}_{dark\_pixel}}{{l}_{dw}} \geq {C}_{4} is true , then BA is true . & ( 18 ) \\ If \frac{{N}_{dark\_pixel}}{{l}_{dw}} < {C}_{4} is true , then BA is false . & ( 19 )\end{matrix}$$

where l_{dw} is the length of the detective interval (i.e., the l length of the detection window), C₄ is a constant and N_{dark}_{_{—}}ₚᵢₓₑₗ is the amount of the pixels satisfying the dark-color character. N_{dark}_{_{—}}ₚᵢₓₑₗ is usually selected as the amount of the pixels included in the length of C₅×l_{dw} in the bottom of the detection window and C₅ is a constant.
In addition, the shadow pixel meeting relationship (20) below is viewed as a dark pixel satisfying the dark-color character, which satisfies the dark-color character. (That is, relationship (20) is the criterion of the dark-color character.)
   R≦C₆×RR, for color images; Gray≦C₇×Grayᵣ, for gray-scale images (20)
   where R denotes the red pixel value and RR denotes the average pixel value of red, green and blue pixel of the road for color images, the red pixel value is preferred; Gray denotes the gray pixel value for gray-scale images and Grayᵣ denotes the gray pixel value of the road. C₆ and C₇ are constants. Regarding obtaining the pixel values of the gray road, we usually scan a group of pixels satisfying the gray character, and calculate an average of pixel values of the group of pixels of the road.
Furthermore, the average of pixel values of the group of pixels of the road can be used to determine the lightness of the sky and to adjust automatically the brightness of the headlights.
The pixel group (pₛ) of the scanning lines 40, the collection of the dark pixels satisfying relationship (20), will be viewed as the rear of front car in image. If the relative speed of the system carrier 24 with respect to the front car is not equal to the absolute speed of the system carrier 24, the item C₆×RR in relationship (20) shall be replaced with ν_{Ps}, and the term C₇×Gray shall be replaced with ν′_{Ps}. For the color images, ν_{Ps} means the red color value of pₛ and for the gray-scale images, ν_{Ps} means gray level color of pₛ.
(d.2) The character of brightness decay of the projected light or the reflected light from the obstacle 21: Under poor lightness conditions during the day, similar to those at night, the image recognition can be performed according to brightness. If brightness distribution is the only base for recognizing the obstacle, more computation resource is consumed and the determined position of the obstacle is not precise because there is a distribution of multiple pixel values in brightness. We introduce another Boolean variable BB regarding the brightness decay character of the projected light or the reflected light from the obstacle 21 to assist to recognize the obstacle, where the true value of BB is determined by relationship (21) below.
   If R≧C₈ or Gray≧C₉ is true, then BB is true. (21)
   where C₈ and C₉ are critical constants, R is the red pixel value for color images and Gray is the gray pixel value for gray-scale images.
(e) Recognizing the obstacle 135: Two Boolean variables regarding the dark-color character under the obstacle and the brightness decay character of the projected light or the reflected light from the obstacle are indicated by BA and BB, respectively. In addition, the day recognition and the night recognition are different. The day recognition operates according to the Boolean variable regarding the shadow character of the obstacle BA, and the night recognition operates according to the brightness decay character of the projected light or the reflected light from the obstacle BB. The time of switching between the day recognition and the night recognition is set in the operation unit 2 in the system carrier 24, depending the conditions of the weather and the brightness of the sky. The principles of the day recognition and the night recognition comprise:
   (e.1) When the day recognition is used, if BA is true, then the obstacle 21 is recognized as the obstacle 21 with dark pixels, which is a car, a motorcycle or a bicycle, i.e., a vehicle on land.
   (e.2) When the day recognition is used, if BA is false, then the obstacle 21 is recognized as the obstacle 21 without darkpixels, which is a road marking, a tree shadow, a protection railing, a mountain, a house, a median or a person.
   (e.3) When the night recognition is used, if BB is true, then the obstacle 21 is recognized as a three-dimensional object, which is a car, a motorcycle, a protection railing, a mountain, a house, a median or a person.
   (e.4) When the night recognition is used, if BB is false, then the obstacle 21 is recognizes as a road marking or nothing.
   FIGS. 13(a), 13(b) and 13(c) include seventeen sub-figures from (a) to (q), which illustrate the recognized results according to the principles described in the step of recognizing the obstacle 135. In FIGS. 13(a), 13(b) and 13(c), the single line scan mode is used for recognizing the obstacle 21 on the road to verify the step of recognizing the obstacle 135. The experimental results are shown in Table 4A and Table 4B below.
   The sub-figures (a)˜(k) in FIG. 13(a) and FIG. 13(b) are illustrations of the experiments using the day recognition, which operates according the Boolean variable BA. The sub-figures (l)˜(q) are illustrations of the experiments using the night recognition, which operates according the Boolean variable BB.

In the sub-figures (a)˜(q), the line L1 indicates the scanning range used at the single line scan mode; the line L2 indicates a boundary threshold given by experiences (the boundary threshold is set to 25 in this embodiment, which is the horizontal coordinate distance between the line L1 and the line L2). If the Euclidean distance of pixel values of a pixel and its adjacent pixel, which both are in the line L1, is larger than the given boundary threshold, the pixel is treated as a border point. When the day recognition is applied, the Boolean variable BA is mainly used for recognition. The line L3, a horizontal line, is used to recognize the position of the obstacle 21 belonging to an object with dark-color pixels, which is classified as Obstacle o1. The line L4, another horizontal line, indicates the position of a border point of the obstacle 21 belonging to an object without dark-color pixels, in which the border point is the nearest border point from the obstacle 21 to the system carrier 24. The object without shadow pixels may be a road marking, a tree shadow, a protection railing, a mountain, a house, a median or a person, which is classified as Obstacle o2. When the night recognition is applied, the Boolean variable is mainly used for recognition. The line L5, in sub-figures (l)˜(q), indicates the position of a three-dimensional object, such as a car, a motorcycle, a protection railing, a mountain, a house, a median, or a person. The three-dimensional object, which has the character/function of emission/reflection of light, is classified as Obstacle o3.

TABLE 4A
Recognition results of sub-figures (a)˜(k)
according to the day recognition

| Sub-figure | $\begin{matrix}\frac{{N}_{shadow\_pixel}}{{l}_{dw}} in ( 18 ) \\ and ( 19 ) , where {C}_{4} \\ is set to 0.1\end{matrix}$ | Boolean variable BA | Result of recognition |
|---|---|---|---|
| (a) car | 0.416 | true | Classified |
| | | | as Obstacle |
| | | | o1 by L3 |
| (b) car/ | 0.588 (car)/0 | true/false | Classified |
| tree shadow | (tree shadow) | | as Obstacle |
| | | | o1 by L3/ |
| | | | Classified |
| | | | as Obstacle |
| | | | o2 by L4 |
| (c) car/ | 0.612 (car)/0 (road | true/false | Classified |
| road | marking) | | as Obstacle |
| marking | | | o1 by L3/ |
| | | | Classified |
| | | | as Obstacle |
| | | | o2 by L4 |
| (d) | 0.313 (motorcycle) | true/false | Classified |
| motorcycle/ | 0 (road marking) | | as Obstacle |
| road | | | o1 by L3/ |
| marking | | | Classified |
| | | | as Obstacle |
| | | | o2 by L4 |
| (e) bicycle/ | 0.24 (bicycle)/ | true/false | Classified |
| road | 0 (road marking) | | as Obstacle |
| marking | | | o1 by L3/ |
| | | | Classified |
| | | | as Obstacle |
| | | | o2 by L4 |
| (f) | 0 | false | Classified |
| protection | | false | as Obstacle |
| railing | | | o2 by L4 |
| (g) | 0 | false | Classified |
| mountain | | | as Obstacle |
| | | | o2 by L4 |
| (h) house | 0 | false | Classified |
| | | | as Obstacle |
| | | | o2 by L4 |
| (i) median | 0 | false | Classified |
| | | | as Obstacle |
| | | | o2 by L4 |
| (j) person | 0 | false | Classified |
| | | | as Obstacle |
| | | | o2 by L4 |
| (k) car in | 0.416 | true | Classified |
| gray-scale | | | as Obstacle |
| | | | o1 by L3 |

TABLE 4B
Recognition results of sub-figures (l)˜(q) according to the
night recognition

| | pixel value of R or | | |
|---|---|---|---|
| | Gray in (21), where | Boolean | |
| | C₈ and C₉ are | variable | Results of |
| Sub-figure | both set to 200) | BB | recognition |
| (l) front car | 212 | true | Classified as |
| | | | Obstacle o3 by |
| | | | L5 |
| (m) car in the | 219 | true | Classified as |
| oncoming way | | | Obstacle o3 by |
| | | | L5 |
| (n) person on | 207 | true | Classified as |
| motorcycle | | | Obstacle o3 by |
| | | | L5 |
| (o) house | 205 | true | Classified as |
| | | | Obstacle o3 by |
| | | | L5 |
| (p) car in gray- | 234 | true | Classified as |
| scale | | | Obstacle o3 by |
| | | | L5 |
| (q) front car and | 209(front car); | true/false | Classified as |
| road marking | 158(road | | Obstacle o3 by |
| | marking) | | L5, not effected |
| | | | by road |
| | | | marking |

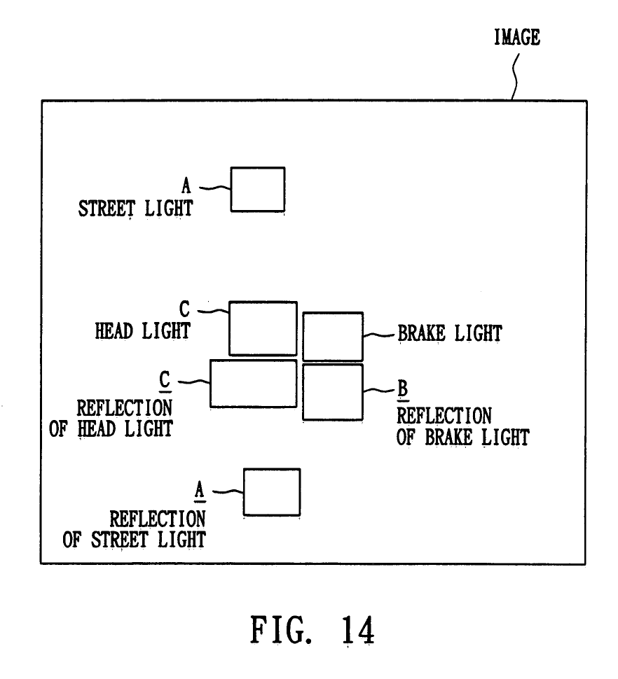

From Table 4A, Table 4B and the illustrations in sub-figures (a)˜(q), utilization of the Boolean variables BA and BB can reliably and precisely recognize the obstacle 21 influencing the traffic safety during the day and at night.
A challenging case during rainy nights may result in errors in recognition. FIG. 14 illustrates the effect of the reflected light from the road during rainy nights. Blocks A, B and C are the positions of reflected light of street light A, brake light B and head light C, respectively, after they emit and reflect on the water on the road (not shown). The distributed character of red (R), green (G) and blue (B) pixel values in Blocks A, B and C is described as follows.
   Block A: R: 200˜250; G: 170˜220; B: 70˜140
   Block B: R: 160˜220; G: 0˜20; B:0˜40
   Block C: R: 195˜242; G: 120˜230;B: 120˜210
In this tough case during a rainy night, if relationship (21) is used for recognition, Blocks A, B and C may be recognized as objects and consequently, the recognitions fails. In order to overcome the failure, an enhanced blue light is installed on the system carrier 24 and a step of identifying the obstacle and the weather during rainy nights is used. The step of identifying the obstacle and the weather during rainy nights includes the following criteria.
(a) When Block A, B or C is scanned, relationship (21) is replaced with relationship (22).
   If B≧C₁₁ or Gray≧C₁₂ is true, then BB is true (22)
   where B is the blue pixel value in color images, Gray is the gray pixel value in gray-scale images; C₁₁ and C₁₂ are both critical constants. By analyzing the color images or the gray-scale images, when red pixel value increases to C₁₁ or gray pixel value decreases to C₁₂, Block A, B or C is generally the position of the obstacle 24.
(b) Block A and B, in FIG. 14 for example, are not recognized as obstacles.
(c) Block B, in FIG. 14 for example, is recognized as an obstacle.
(d) When the blue pixel value of the blue light that is emitted from an enhanced blue light installed on the system carrier 24 and then reflected from the obstacle 21 reaches a specific value, the blue light is recognized as the reflected light of the three-dimensional object (i.e., the obstacle 21) or as the reflected light of the water on the road. In addition, the water on the road can is used to recognize the weather (rainy or not). Block A, in FIG. 14 for example, is recognized as a “non-obstacle”, but the water on the road.
(e) Although Block C, in FIG. 14 for example, is recognized as an obstacle 21, it is not located at the same lane as the system carrier 24. This is used to determine the obstacle distance, the distance from the image sensor 22 to the obstacle 21 that is equivalent to the position of head light C. By simple geometry, relationship (23) is obtained.
   Obstacle distance=(Block C distance in FIG. 14)×(height of the head light C+height of the image sensor)/height of the image sensor (23)
   where Obstacle distance means the distance from the image sensor 22 to the obstacle 21, Block C distance in FIG. 14 means the distance from the position of Block C in the three-dimensional real space to the obstacle 21. If the Block C is located at the same lane as the system carrier 24, Obstacle distance is equal to Block C distance in FIG. 14.

Referring to FIG. 9, Step 14 is to obtain an absolute velocity of the system carrier 24, which is explained in detail as follows.
(a) After the first point P1 of the first image (i.e., the first position) is found, which is an end point of the first character line segment 32, the position of the first point P1 of the second image (i.e., the second position) is then found. Here, the first character line segment 32, a median of the road, is assumed as a white line segment.
(b) In general, the second position is closer to the system carrier 24. The second position can be obtained by scanning horizontally downward with an increment of three to five meters or by scanning according to the slope of \overline{p1p2}, the first character line segment 32.
(c) Comparing the position change between the first and the second positions (i.e., the movement distance of the image sensor 22 on the system carrier 24), calculating the time period between the first and the second images captured and then the absolute velocity of the system carrier 24 is obtained, by dividing the position change by the time period. The first and the second images belong to the plural images of the obstacle 21, and the second image is captured later than the first image. Also, the absolute velocity can be obtained directly from the speedometer of the system carrier 24.

Step 15 is to obtain a relative velocity and a relative distance of the system carrier 24 with respect to the obstacle 21, which is explained in detail as follows. After the position of the obstacle 21 in the image is determined, a relative distance L of the system carrier 24 with respect to the obstacle 21 is obtained by relationships (1)˜(6), and is given as relationship (24) below.

$$L = \frac{{H}_{c}}{tan ( {θ}_{1} + {tan}^{- 1} ( \frac{{p}_{l} \times Δ {p}_{l}}{f} ) )} \qquad ( 24 )$$

where the depression angle of the image sensor 22 (θ₁), the distance from the image sensor 22 to the ground (i.e., the height of the image sensor 22, H_{c}), the focus of the image sensor 22 (ƒ) and the interval of pixels on the image plane (Δp₁) are already known, and pₗ is the position of the obstacle 21 in the image, which was also obtained. A relative velocity (RV) of the system carrier 24 with respect to the obstacle 21 is obtained by relationship (25) below.

$$RV = \frac{Δ L ( t )}{Δ t} \qquad ( 25 )$$

where Δt and ΔL(t) are representative of the time period between the first and the second images captured and the difference between the relative distance at time when the first image captured and the relative distance at time when the second image captured, respectively.

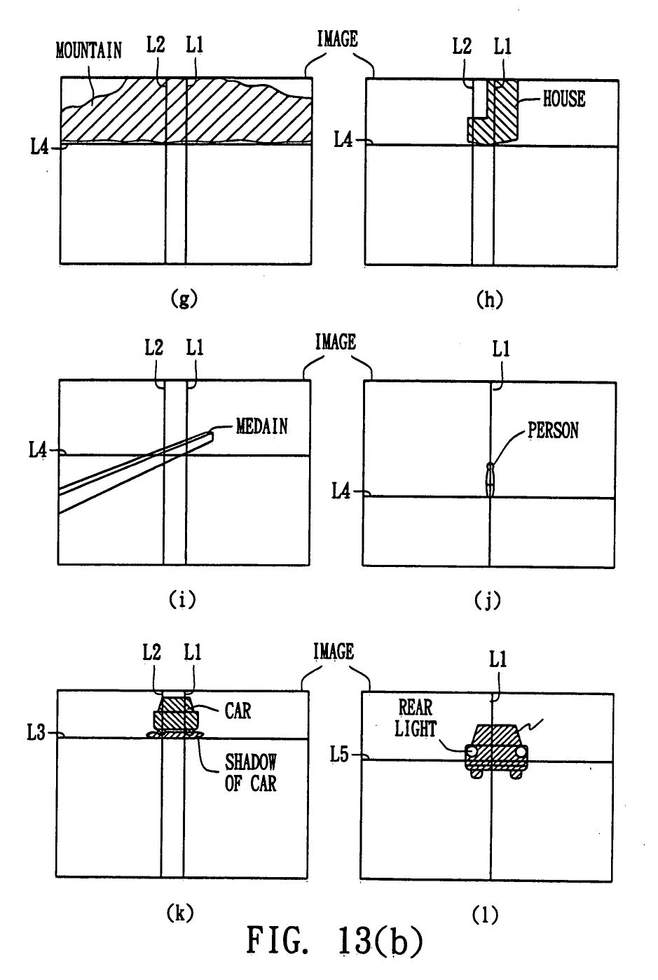

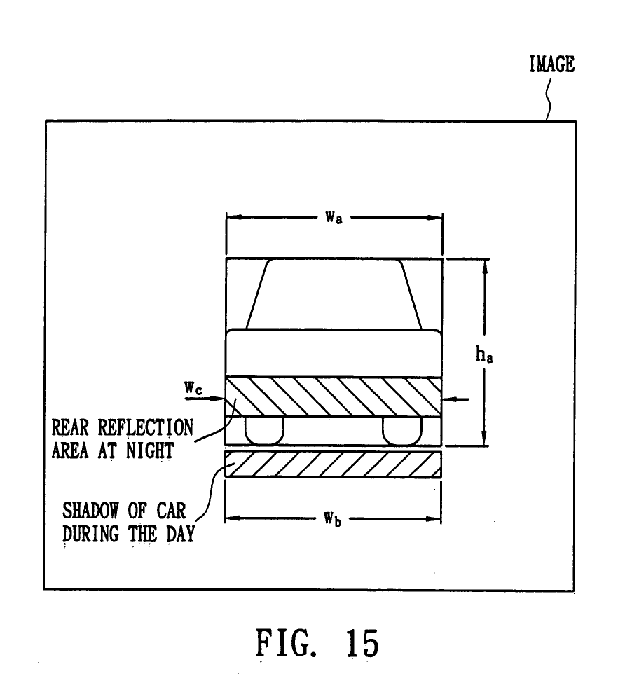

Step 16 is to perform a strategy of obstacle avoidance (refer to FIG. 12), which comprises the steps (a)˜(h) below.
(a) Providing an equivalent velocity 161, which is the larger of the absolute velocity of the system carrier 24 and the relative velocity of the system carrier 24 with respect to the obstacle 21.
(b) Providing a safe distance 162, which is roughly equal to from 1/2000 of the equivalent velocity to ( 1/2000 of the equivalent velocity+10 meters). In one preferred embodiment, the safe distance (unit in meter) is defined as a half of the value of the equivalent velocity (unit in km/hour) plus five.
(c) Providing a safe coefficient 163, which is defined as the ration of the relative distance to the safe distance and is between zero and one.
(d) Providing an alarm signal 164, which is defined by subtracting the safe coefficient from one.
(e) Based on the alarm signal, alerting a driver of the system carrier 24 by light, sound or vibration, and alerting surrounding persons by light or sound 165.
(f) Capturing and displaying a frame of the obstacle in the images 166. In the embodiment of a car as the obstacle 21, referring to FIG. 15, the width ofthe frame is wₐ, which is the width (w_{b}) of the dark-color pixels of the car during the day and which is the width (w_{c}) of rear reflection area at night. hₐ is the height of the frame, which is l_{dw} in relationship (11).
(g) Providing a sub absolute velocity 167, which is defined as the product of the safe coefficient and the current absolute velocity of the system carrier 24.
(h) Providing an audio/video recording 168. In one preferred embodiment, the audio/video recording starts only when the safe coefficient is below a specific value, for example 0.8, to record the situations before an accident happens. Thus, it is not necessary to keep recording all the time.

Although a car is used as an example of the obstacle 21 in the majority of the aforementioned embodiments, all the obstacles 21 with border character can be recognized by the present invention of the method for obstacle avoidance with camera vision. Therefore, the obstacle 21 is a car, a motorcycle, a truck, a train, a person, a dog, a protection railing, a median or a house.

Although a car is used as an example of the system carrier 24 in the majority of the aforementioned embodiments, the system carrier 24 in not limited to the car. Therefore, the system carrier 24 is any kind of vehicles, such as a motorcycle, a truck and so on.

In the aforementioned embodiments, the image sensor 22 is a device, which can capture images. Accordingly, the image sensor 22 is a CCD (Charge Coupled Device) camera, a CMOS camera, a digital camera, a single-line scanner or a camera installed in handheld communication equipment.

The above-described embodiments of the present invention are intended to be illustrative only. Numerous alternative embodiments may be devised by persons skilled in the art without departing from the scope of the following claims.

What is claimed is:

1. A method for obstacle avoidance with camera vision, which is applied in a system carrier carrying an image sensor, comprising the steps of:
capturing and analyzing plural images of an obstacle;
positioning the image sensor;
performing an obstacle recognition flow;
obtaining an absolute velocity of the system carrier;
obtaining a relative velocity and a relative distance of the system carrier with respect to the obstacle; and
performing a strategy of obstacle avoidance.

2. The method for obstacle avoidance with camera vision of claim 1, wherein the step of positioning the image sensor is used to obtain the depression angle of the image sensor, the distance from the image sensor to the ground, the focus of the image sensor and the interval of pixels on the image plane.

3. The method for obstacle avoidance with camera vision of claim 2, wherein the step of obtaining the depression angle of the image sensor and the distance from the image sensor to the ground comprises the steps of:
scanning horizontally the images of the obstacle from bottom to top with an interval;
recognizing a character point having the character of sidelines of the road;
recognizing two first points on a first character line segment containing the character point;
scanning horizontally through the two first points to obtain two horizontal lines intersecting a second character line segment at two second points;
recognizing an intersection point of a line formed by the two first points and a line formed by the two second points;
obtaining a depression angle of the image sensor; and
obtaining a distance from the image sensor to the ground.

4. The method for obstacle avoidance with camera vision of claim 3, wherein the steps of obtaining the depression angle of the image sensor and the distance from the image sensor to the ground comprises the steps of:
calculating a focus of the image sensor; and
calculating an interval of pixels on the image plane.

5. The method for obstacle avoidance with camera vision of claim 3, wherein the depression angle of the image sensor is calculated according to the interval of pixels on the image plane, the focus of the image sensor, the intersection point and a half of the vertical length of the images.

6. The method for obstacle avoidance with camera vision of claim 3, wherein the distance from the image sensor to the ground is calculated according to the depression angle of the image sensor, the distance from one of the two horizontal lines to the image sensor and the relative distance from the other horizontal line to the image sensor.

7. The method for obstacle avoidance with camera vision of claim 3, wherein the depression angle of the image sensor is determined by the following equation:
$${θ}_{1} = {tan}^{- 1} ( \frac{Δ {p}_{l} * ( c - {y}_{l} )}{f} ) ,$$
wherein θ₁ is the depression angle of the image sensor, Δpₗ is the interval of pixels on the image plane, c is a half of the vertical length of the images, y₁ is the position of the intersection point and ƒ is the focus of the image sensor.

8. The method for obstacle avoidance with camera vision of claim 3, wherein the distance from the image sensor to the ground is determined by the following equation:
$${H}_{c} = \frac{{C}_{1}}{( \frac{1}{tan ( {θ}_{1} + {θ}_{2} )} - \frac{1}{tan ( {θ}_{1} + {θ}_{2}^{′} )} )}$$
wherein H_{c} is the distance from the image sensor to the ground, C₁ is the length of a line segment on the road, θ₁ is the depression angle of the image sensor, θ₂ and θ₂′ satisfy
$$La = \frac{{H}_{c}}{tan ( {θ}_{1} + {θ}_{2} )} and {La}^{′} = \frac{{H}_{c}}{tan ( {θ}_{1} + {θ}_{2}^{′} )} ,$$
where La is the distance from one of the two horizontal lines to the image sensor and La′ is the distance from the other horizontal line to the image sensor.

9. The method for obstacle avoidance with camera vision of claim 3, the focus of the image sensor and the distance from the image sensor to the ground are determined by the following equations:
$${H}_{c} \times ( \frac{tan ( {θ}_{1} + {θ}_{2}^{′} ) - tan ( {θ}_{1} + {θ}_{2} )}{tan ( {θ}_{1} + {θ}_{2} ) \times tan ( {θ}_{1} + {θ}_{2}^{′} )} ) = {C}_{1} , \\ {H}_{c} \times ( \frac{tan ( {θ}_{1} + {θ}_{2}^{′′} ) - tan ( {θ}_{1} + {θ}_{2} )}{tan ( {θ}_{1} + {θ}_{2} ) \times tan ( {θ}_{1} + {θ}_{2}^{′′} )} ) = {C}_{10}$$
wherein C₁ is the length of a line segment on the road, C₁₀ is an interval of line segments on the road, H_{c} is the distance from the image sensor to the ground, θ₁ is the depression angle of the image sensor; H_{c}, θ₁, θ₂, θ₂′ and θ₂″ are functions of f and Δp₁, f is the focus of the image sensor, Δpₗ is the interval of pixels on the image plane, θ₂ and θ₂′ satisfy
$$La = \frac{{H}_{c}}{tan ( {θ}_{1} + {θ}_{2} )} and {La}^{′} = \frac{{H}_{c}}{tan ( {θ}_{1} + {θ}_{2}^{′} )} ,$$
where La is the distance from one of the two horizontal lines to the image sensor and La′ is the distance from the other horizontal line to the image sensor.

10. The method for obstacle avoidance with camera vision of claim 1, wherein the step of performing an obstacle recognition flow comprises the steps of:
setting a scan mode that is selected from the group of a single line scan mode, a zigzag scan mode, a three-line scan mode, a five-line scan mode, a turn-type scan mode and a transverse scan mode;
providing a border point recognition;
setting a scan type that is a detective type or a gradual type;
providing two Boolean variables regarding a dark-color character of the obstacle, and a brightness decay character of the projected light or a reflected light from the obstacle; and
recognizing the obstacle type.

11. The method for obstacle avoidance with camera vision of claim 10, wherein the step of providing the border point recognition comprises the steps of:
calculating a Euclidean distance of pixel values between a pixel and its adjacent pixel; and
treating the pixel as the border point if the Euclidean distance is larger than a critical constant.

12. The method for obstacle avoidance with camera vision of claim 10, wherein the Boolean variable regarding the dark-color character of the obstacle is true, if
$$\frac{{N}_{dark\_pixel}}{{l}_{dw}} \geq {C}_{4}$$
is true, where C₄ is a constant, l_{dw} is the length of the detective interval, and N_{dark}_{_{—}}ₚᵢₓₑₗ is the amount of the pixels satisfying the dark-color character.

13. The method for obstacle avoidance with camera vision of claim 12, wherein the criterion of the dark-color character is given as: R≦C₆×RR for the color images and Gray≦C₇×Grayᵣ for gray-scale images, wherein R denotes the red pixel value and RR denotes the average pixel value of red, green and blue pixel of the road for color images; Gray denotes the gray pixel value for gray-scale images and Grayᵣ denotes the gray pixel value of the road; C₆ and C₇ are constants.

14. The method for obstacle avoidance with camera vision of claim 13, wherein when the relative speed of the system carrier with respect to the obstacle does not equal the absolute speed of the system carrier, the item C₆×RR is replaced with the red color value of a pixel group and the item C₇×Gray is replaced with the gray level color of the pixel group.

15. The method for obstacle avoidance with camera vision of claim 10, wherein the Boolean variable regarding the brightness decay character of the projected light or the reflected light from the obstacle is true, if R≧C₈ or Gray≧C₉ is true, where C₈ and C₉ are critical constants, R is the red pixel value in color images, Gray is the gray pixel value in gray-scale images.

16. The method for obstacle avoidance with camera vision of claim 10, further comprising the step of recognizing the obstacle and weather at rainy night, which is performed according to the character of the blue pixel value of the blue light that is emitted from an enhanced blue light installed on the system carrier and then reflected from the obstacle.

17. The method for obstacle avoidance with camera vision of claim 16, wherein the Boolean variable regarding the brightness decay character of the projected light or the reflected light from the obstacle is true, if B≧C₁₁ or Gray≧C₁₂ is true, where C₁₁ and C₁₂ are critical constants, B is the blue pixel value in color images, Gray is the gray pixel value in gray-scale images.

18. The method for obstacle avoidance with camera vision of claim 10, further comprising the step of switching between a day recognition and a nigh recognition, wherein the day recognition operates according to the Boolean variable regarding the dark-color character of the obstacle, the night recognition operates according to the Boolean variable regarding the brightness decay character of the projected light or the reflected light from the obstacle, and the time of switching is set in an operation unit in the system carrier.

19. The method for obstacle avoidance with camera vision of claim 10, wherein if the Boolean variable regarding the dark-color character of the obstacle is true, the obstacle is identified as an object with dark-color pixels below.

20. The method for obstacle avoidance with camera vision of claim 10, wherein if the Boolean variable regarding the brightness decay character of the projected light or the reflected light from the obstacle is true, then the obstacle is identified as a three-dimensional object.

21. The method for obstacle avoidance with camera vision of claim 10, further comprising the step of switching automatically between the high beam and the low beam, which operates when the distance between the system carrier and the obstacle in the oncoming way is below a specific distance.

22. The method for obstacle avoidance with camera vision of claim 10, further comprising the step of adjusting automatically the brightness of the headlights, which operates according to the lightness of the sky, determined by the average of the pixel values of the group of pixels of the road.

23. The method for obstacle avoidance with camera vision of claim 1, wherein the step of obtaining the absolute velocity of the system carrier comprises the steps of:
recognizing a first position of an end point of a character line segment in a first image;
recognizing a second position of the end point of the character line segment in a second image;
dividing the distance between the first position and the second position by the time interval between capturing the first and the second images, which belong to the plural images of the obstacle, with the first image captured earlier than the second image.

24. The method for obstacle avoidance with camera vision of claim 1, wherein the step of performing the strategy of obstacle avoidance comprises the steps of:
providing an equivalent velocity, which is the larger one of the absolute velocity and the relative velocity;
providing a safe distance determined by the equivalent velocity;
providing a safe coefficient, which is the ratio of the relative distance to the safe distance and is between zero and one;
providing an alarm signal, which is defined by subtracting the safe coefficient from one;
generating light, sound or vibration to alert a driver of the system carrier or surrounding persons based on the alarm signal;
capturing and displaying a frame of the obstacle in the images;
providing a sub absolute velocity, which is the product of the safe coefficient and the current absolute velocity of the system carrier; and
performing an audio/video recording.

25. The method for obstacle avoidance with camera vision of claim 24, wherein the audio/video recording is performed when the safe coefficient is below an empirical value.

26. The method for obstacle avoidance with camera vision of claim 1, wherein the absolute velocity is obtained directly from a speedometer of the system carrier.

27. The method for obstacle avoidance with camera vision of claim 1, wherein the image sensor is selected from the group of a CCD camera, a CMOS device camera, a digital camera, a single-line scanner and a camera installed in a handheld communication equipment.

28. An apparatus for obstacle avoidance with camera vision, which is applied in a system carrier, comprising:
an image sensor, which captures plural images of an obstacle and is used to recognize the obstacle; and
an operation unit, which performs the following functions:
(a) analyzing the plural images;
(b) performing an obstacle recognition to determine if the obstacle exists according to the result of analyzing the plural images; and
(c) performing a strategy of obstacle avoidance.

29. The apparatus for obstacle avoidance with camera vision of claim 28, further comprising an alarm, which emits light and sound or generates vibration if the obstacle exists.

30. The apparatus for obstacle avoidance with camera vision of claim 28, wherein the image sensor is selected from the group of a CCD camera, a CMOS device camera, a digital camera, a single-line scanner and a camera installed in a handheld communication equipment.
